(19) United States
(12) Patent Application Publication
(10) Pub. No.: US 2011/0140364 A1
(43) Pub. Date: Jun. 16, 2011

(54) SEAL, ASSEMBLY AND METHOD, PARTICULARLY FOR DOWNHOLE ELECTRIC CABLE TERMINATIONS

(75) Inventor: Philip Head, Surrey (GB)

(73) Assignee: ARTIFICIAL LIFT COMPANY LIMITED, Surrey (GB)

(21) Appl. No.: 12/965,474

(22) Filed: Dec. 10, 2010

(30) Foreign Application Priority Data
Dec. 10, 2009 (GB) 0921634.2

(51) Int. Cl. H02G 15/04; H02G 15/02

(52) U.S. Cl. 277/314; 277/607

(57) ABSTRACT

A seal assembly (10′; 30′) comprises a plurality of deformable annular seals (10; 30), each having an annular recess (17) at one end, which are inserted one by one in a relaxed condition in coaxial stacked relation into an annular bore (54) and then compressed axially one by one so that an insert body (16; 32) enters into the recess in each seal, radially energising it. The insert body may comprise an opposite end (16) of the adjacent seal, or a body (32) of fluid or gel. The inner wall of each seal comprises a sealing surface and at least one sealing bead protruding radially inwardly from the sealing surface; the sealing surface limits the depth to which the bead can penetrate the casing of the cable.

### PRIORITY INFORMATION

This application claims priority from United Kingdom patent application no. GB 0921634.2, filed 10 Dec. 2009.

### FIELD OF THE INVENTION

This invention relates to seals and seal assemblies for use in termination sleeves, particularly but not exclusively for use on electric cables for deployment in boreholes and other pressurised fluid environments.

### BACKGROUND OF THE INVENTION

Electric cables such as power cables, data transmission cables and the like which are deployed in oil wells and other deep boreholes are subjected to a high pressure fluid environment, and often also to elevated temperatures. Where the cable enters a termination sleeve it is necessary to seal the tubular casing of the cable in the termination sleeve in order to prevent the pressurised ambient well fluid from reaching the conductor.

In this specification, a “tubular casing” is an elongate, tubular layer surrounding an elongate part to be protected. Where the tubular casing comprises the outer protective layer of a cable, the protected part could be a conductor or a group of conductors of the cable, for example, electrical or fibre-optic conductors. Where the tubular casing comprises the outer wall of a flexible pipe, the protected part may be the fluid-carring bore or lumen of the pipe. In this specification, a “cable” is at least one elongate conductor which is surrounded by at least one tubular casing, which may comprise a layer of insulation and/or wire or tubular metallic armour, and a “termination sleeve” is any connection element comprising a body with a bore that is adapted to sealingly receive a tubular casing so as to facilitate a connection to its protected part. A termination sleeve for a cable will facilitate an electrical connection to its conductor, while a termination sleeve for a pipe will facilitate a fluid connection to its bore or lumen. Termination sleeves for cables may be found for example on downhole pump motors and other electrical apparatus to which the cable provides a power or data connection; on cable joints for connecting two lengths of cable end to end; and on connection devices for releasably connecting the cable to electrical equipment.

It is known to seal a tubular casing in a termination sleeve by arranging a cylindrical elastomeric seal between the casing and the sleeve and then compressing it axially so as to radially energise it, which is to say, to cause the seal to exert a sealing force radially outwardly against the sleeve and inwardly against the casing.

(In this specification, “cylindrical” means: having a circular or approximately circular cross-section and axially parallel or approximately parallel walls. When applied to a deformable seal it will be appreciated that slightly axially curved or tapering walls may function as effectively or nearly as effectively as perfectly parallel walls, and may be considered as effectively cylindrical as long as the rate of taper is not so much as to significantly reduce the sealing performance.)

Although such seals may advantageously provide a large, flat area of contact which does not damage the casing of the cable, it is difficult to insert them into the annulus between the casing and the sleeve while also making them tight enough to be effective. If the seal is axially elongate, it is also difficult to determine over what part of its length it is effectively energised, and hence it is difficult to determine how much radial sealing force it exerts. The design of such seals is therefore a compromise between effectiveness and ease of installation.

Such seals are employed in diverse conditions, e.g. in boreholes of varying depths, and it is particularly difficult to design the seal to suit the ambient pressure it must withstand. Increasing the axial length of a cylindrical seal may not increase its sealing force.

“O”-ring seals are one alternative commonly used to effect a seal between a tubular casing and a termination sleeve. Due to its circular longitudinal section (through the torus in the plane of its axis) an “O”-ring seal will apply an annular point load to the casing and sleeve, which provides a more reliable radial sealing force. However, where the casing comprises a non-metallic material, e.g. plastics or elastomeric material, the localised sealing force will tend to displace the casing material over time from the region of the seal, gradually reducing the sealing force. This may occur particularly where the casing is softened by raised temperatures, such as where the casing surrounds an electric cable carrying a heavy current, and/or where the ambient fluid environment is heated, such as may occur in deep boreholes. The problem is particularly acute in electric cables having an outer layer of non-metallic insulation, since pressure applied against the insulation is reacted against the non-compressible metal core of the cable, which causes the insulation to creep away from the seal and eventually to split. By increasing the compression (radial energisation) of the seal, the likelihood of damaging the cable insulation is also increased. It can also be difficult to insert the “O”-ring seal into the annular gap between the casing and the sleeve, by which procedure it is compressed and energised.

Photographic evidence (FIGS. 1A and 1B) shows damage to two electric cables forming part of a three-phase power supply to an electric submersible pump which was recovered from an oil well. The cables were sealed in respective termination sleeves on the pump casing using prior art “O”-ring seals. A first photograph (FIG. 1A) shows one of the cables 1 after removal from the termination sleeve, in which the “O”-ring seal 2 has caused the insulating casing material 3 of the cable to creep away from the point of contact 4 with the seal. This has reduced the sealing force against the cable and hence the effectiveness of the seal. A second photograph (FIG. 1B) shows the adjacent cable 1′, in which the pressure from the “O”-ring seal 2′ has caused the insulated casing 3′ to split, exposing the conductor 5.

WO03/102360 discloses a high temperature and pressure seal comprising a stack of chevron packing rings.

### SUMMARY OF THE INVENTION

It is the object of the present invention to provide a more effective and more convenient way of terminating a cable in a high pressure fluid environment while avoiding damage to the tubular casing of the cable.

In accordance with the various aspects of the present invention there are provided respectively a seal assembly, a seal, and a method as defined in the claims.

### BRIEF DESCRIPTION OF THE DRAWINGS

Some illustrative embodiments of the invention will now be described, purely by way of example and with reference to the accompanying drawings, in which:

FIGS. 1A and 1B show prior art cable seals as described above;

FIG. 2A is a longitudinal section through a first seal in accordance with a first embodiment;

FIG. 2B is a longitudinal section through a first seal assembly comprising a compressed stack of seals according to the first embodiment;

FIG. 2C is a detail view of part of the first seal as shown in FIG. 2A;

FIG. 3A is a longitudinal section through a second seal in accordance with a second embodiment;

FIG. 3B is a longitudinal section through a second seal assembly comprising a compressed stack of seals according to the second embodiment;

FIGS. 4, 5 and 6 are longitudinal sections through a termination sleeve and seal assembly showing steps in sealing an electric cable in a termination sleeve by means of a compressed stack of seals according to the second embodiment;

FIG. 7 is a cross section through the installation tool shown in FIG. 5 partly assembled around a cable;

FIG. 8 is a longitudinal section through a termination sleeve in which a cable is sealed by means of two energised stacks of seals according to the first embodiment; and

FIG. 9 shows the section of FIG. 8 with the pressure test sleeve removed from the termination sleeve.

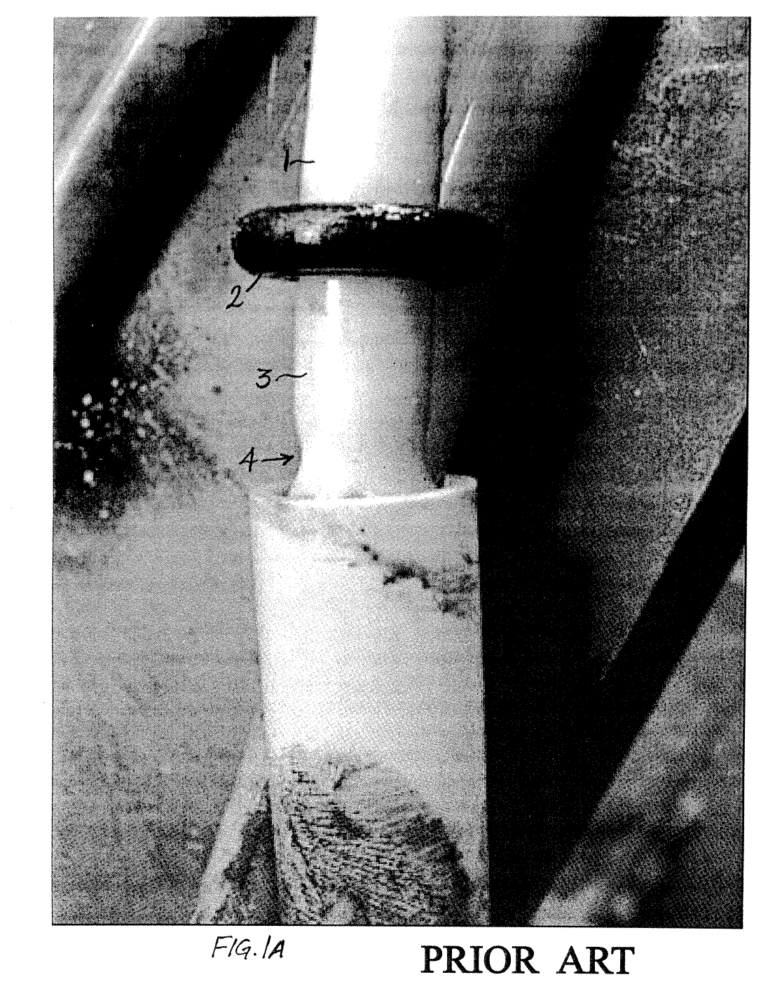

Corresponding reference numerals refer to corresponding parts in each of the figures.

### DETAILED DESCRIPTION OF PREFERRED EMBODIMENTS

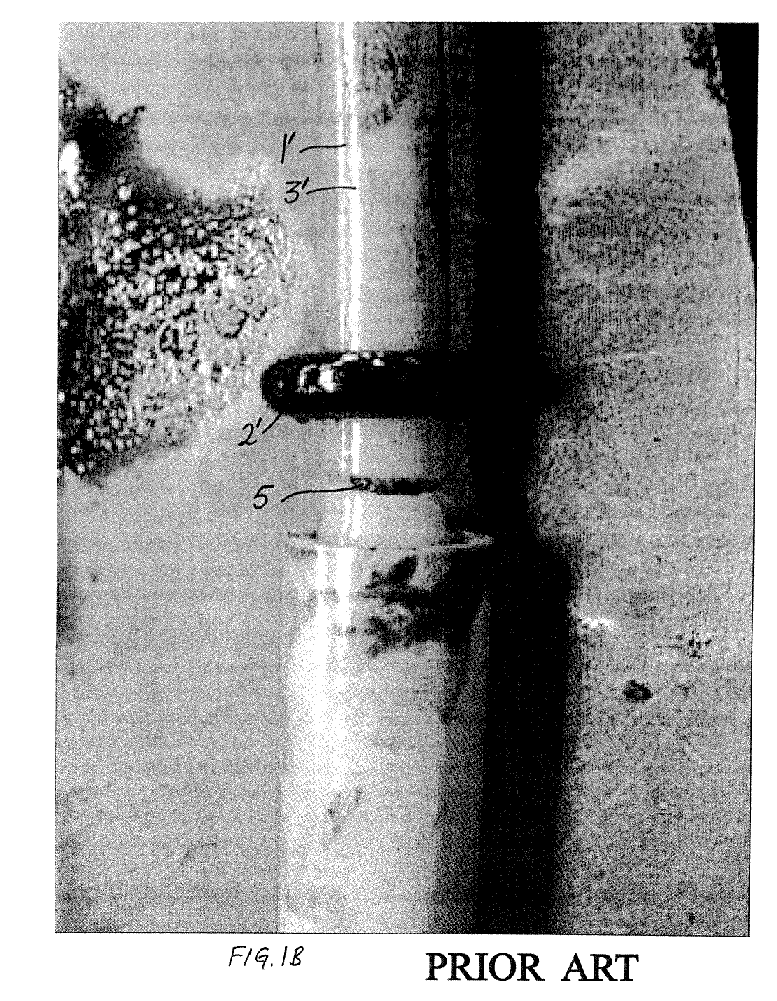

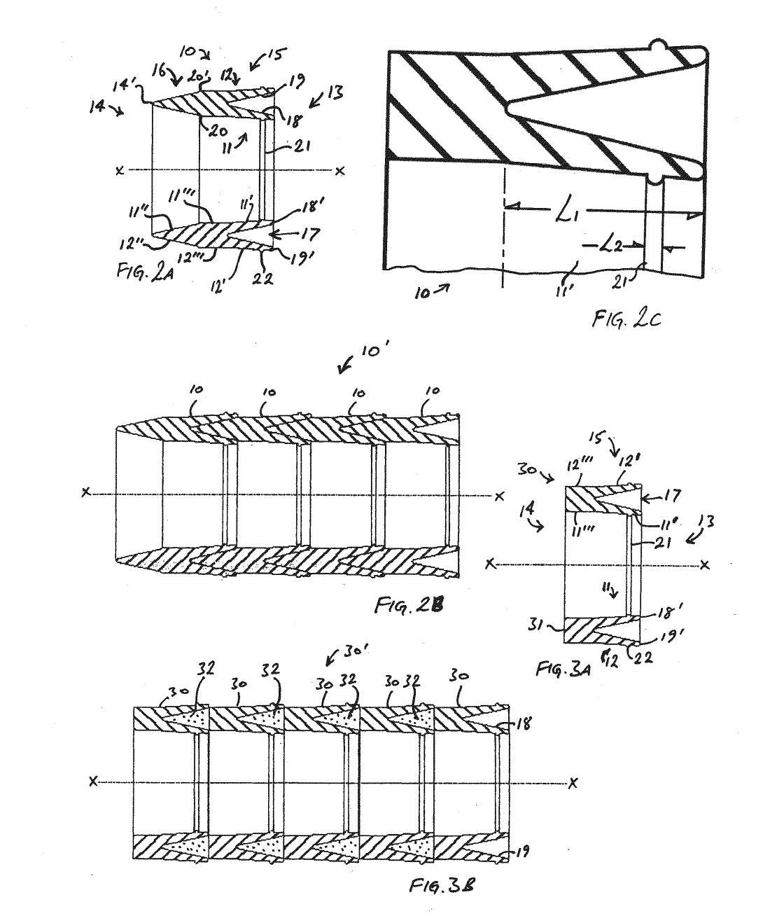

Referring to FIGS. 2A and 2B, a first annular seal 10 is made from an elastically deformable, e.g. elastomeric material. A recessed portion 15 is formed proximate the first axial end 13, while a tapered insert body 16 is formed proximate the second axial end 14. The recessed portion 15 comprises a radially inner wall 11 and a radially outer wall 12.

The recessed portion comprises an annular recess 17 which extends axially from the first end between the inner and outer walls 11, 12, preferably for at least 30% of the axial length of the seal. The recess tapers axially inwardly and in the embodiment shown is generally V-shaped in longitudinal section, with its respective inner 18 and outer 19 internal walls being slightly rounded in longitudinal section so that the recess flares slightly towards its open end.

The inner wall 11 of each seal comprises a sealing surface 11′ and at least one sealing bead 21 protruding radially inwardly from the sealing surface. The outer wall 12 has a similar sealing surface 12′ and sealing bead 22. The or each sealing surface is preferably cylindrical or nearly cylindrical. For example, they may be slightly convexly curved in longitudinal section so that they are also slightly flared towards the first end 13 as shown, where they meet the respective inner 18 and outer 19 internal walls of the recess to define blunt annular tips 18′, 19′, although in alternative embodiments they could be perfectly cylindrical, i.e. straight and parallel with the longitudinal axis X of the seal.

The insert body 16 is also generally “V” shaped and is defined by converging annular walls 11″, 12″ which converge axially outwardly and respectively radially outwardly and inwardly to define a blunt annular tip 14′ at the second end 14 of the seal.

In a relaxed state as shown (FIG. 2A), the sealing surfaces 11′, 12′ of the inner and outer walls are tapered axially less steeply (which is to say, at a smaller angle with respect to the longitudinal axis of the seal) than the corresponding converging portions 11″, 12″, and blend into a short, solid portion of the seal defined by cylindrical, inner 11′ and outer 12′″ walls between the recess and the insert body, which in turn meet the converging portions 11″, 12″ at an angular transition 20, 20′.

The insert body is adapted to enter into the corresponding recess of the adjacent seal in the manner of a wedge so as to radially energise the recessed portion of the adjacent seal when the seals are arranged in stacked coaxial relation as shown in FIG. 2B and compressed together axially along the longitudinal axis X of the seal to form a seal stack 10′. Under axial compression, each insert body enters into the corresponding recess and is progressively compressed therein so that it urges the sealing portions 11′, 12′ respectively inwardly and outwardly against the walls (respectively of a tubular casing and a termination sleeve) defining the annular recess in which the seal stack is assembled as explained in more detail hereafter.

Advantageously, each seal is inserted into the annular recess in a substantially relaxed condition, which makes the seal stack much easier to assemble than the prior art cylindrical or “O”-ring seals. When the seals are compressed axially, the sealing surfaces 11′, 12′ define spaced, annular zones of energisation, which are advantageously spaced apart by the short solid portion of the seal, ensuring that the energisation of one seal does not prevent the insert body of the next seal from entering fully into the respective recess so as to also energise that seal.

Each sealing bead 21, 22 provides a localised, annular energisation zone of enhanced radial compression (energisation). More preferably at least one internal annular protuberance 21 and at least one external annular protuberance 22 are provided, respectively on the inner and outer walls of the seal.

The sealing surfaces 11′, 12′ as well as the cylindrical walls 11′″, 12′″ of adjacent seals in the seal stack 10′ cooperate to form continuous, axially elongate contact regions that extend between the respective sets of sealing beads or protuberances 21, 22 and tips 18′, 19′. These contact regions support, in particular the material of the tubular casing which extends in use through the centre of the seal stack, preventing it from creeping away from the localised energisation zones of high sealing force created by the sealing beads 21 and/or tips 18′, and also limit the depth to which the respective sealing beads 21 and tips 18′ are able to penetrate into the tubular casing. Since the material of the tubular casing is retained in the regions of the energisation zones and prevented from creeping away from them, this provides a greater annular pressure and hence a more effective seal at each of the energisation zones. At the same time, it prevents failure of the casing material in the region of the energisation zones. The seal assembly can thus provide a greater sealing force in each of a plurality of axially spaced energisation zones while avoiding damage to the tubular casing.

In the embodiment shown, the sealing surface 11′ extends axially on either side of the sealing bead 21 and has a greater axial length (L₁ minus L₂) than the axial length (L₂) of the sealing bead 21 (FIG. 2C), more preferably at least about 5 times greater or 10 times greater, as shown. The sealing surface 11′ thus has a relatively large surface area relative to that of the bead 21. This more effectively limits the depth to which the bead 21 can embed into the casing, and so prevents damage in use. In alternative embodiments, two or more sealing beads may be arranged in spaced relation on the sealing surface, in which case the axial length of the sealing surface (defined as its overall length minus the aggregate axial length of all of the sealing beads) is preferably greater than the aggregate (combined) axial length of the sealing beads.

It is found that by arranging the sealing surface on either side (i.e. both sides) of the sealing bead, damage to the casing is reliably avoided. In less preferred embodiments, the sealing surface may extend on only one side of the sealing bead, which may be arranged at the annular tip 18′ of the recessed portion, in which case the sealing bead may function effectively even if it protrudes only very slightly from the sealing surface 11′.

Since the annular compression zones are spaced apart, all of the seals in the stack are able to be compressed one by one to a predictable degree. This advantageously allows the seal stack 10′ to be built from a variable number of seals 10, which are preferably identical and hence interchangeable, with more seals being included as required to provide more effective sealing, depending on the conditions (particularly ambient fluid pressure) under which the seal stack is to be deployed.

Referring to FIGS. 3A and 3B, a second annular seal 30 comprises a recess portion 15 adjoining a solid portion defined by cylindrical walls, these portions having features corresponding to those of the first seal, but differs from the first seal in that no insert body is provided. Instead, the solid, cylindrical portion of the seal terminates at a flat wall 31 defining its second end 14.

The second seals are arranged in stacked coaxial relation to form a seal stack 30′ as shown in FIG. 3B, with an insert body 32 comprising a body of fluid or gel or water-swellable polymer being introduced (for example, injected from a sachet, tube, cartridge gun or other suitable dispensing tool of conventional type) into the annular gap between the tubular casing and the termination sleeve between each pair of adjacent seals. When the seals 30 are compressed together axially along the longitudinal axis X of the seal stack, each fluid or gel insert body 32 is urged by the flat wall 31 of one of the adjacent seals to enter into the recess 17 of the other adjacent seal so as to radially energise the recessed portion of the seal into which it enters, in the same manner as in the first embodiment, with excess fluid or gel escaping between the seals and the casing and/or insert sleeve as the seal stack is progressively compressed. Advantageously, a small amount of the fluid or gel may also escape from the termination assembly to prevent excessive compression if the ambient temperature increases during service. Where water-swellable polymer is used, it advantageously reacts to water leakage through the seal stack by increasing the sealing force.

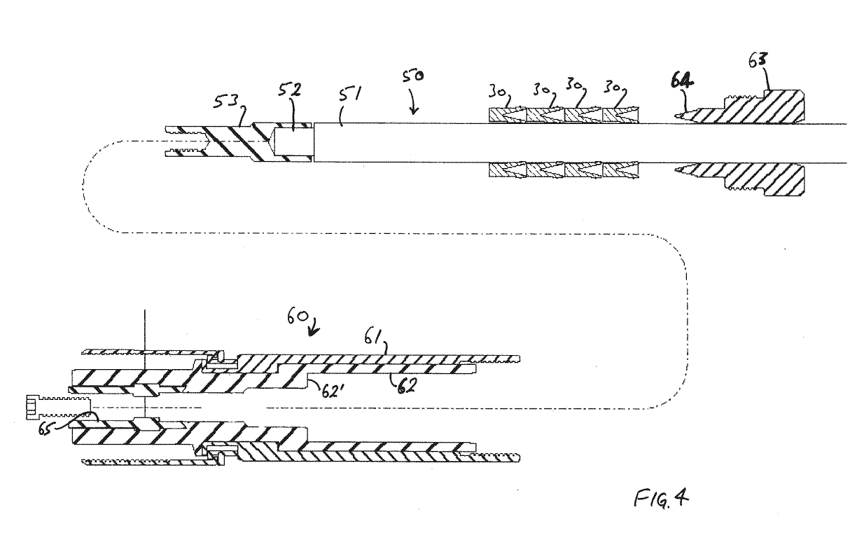

Referring to FIGS. 4-7, a seal stack 30′ in accordance with the second embodiment is assembled using an annular assembly tool 40 so as to seal the tubular casing 51 surrounding the conductor 52 of an electric cable 50 in a termination sleeve 60, comprising an outer metallic sleeve 61, an inner insulating sleeve 62 and a conductive receptacle 65.

The cable 50 is first passed through the annular threaded bush 63 of the termination sleeve, which comprises an annular insert body 64 at one end shaped to enter into the recess 17 of the final seal 30″ so as to energise that seal. A terminal 53 is soldered or crimped onto the exposed conductor 52. Two or more seals 30 are then slid onto the cable around its casing 51 in stacked coaxial relation as shown (FIG. 4).

The cable is then inserted into the insulating sleeve 62 and electrically and mechanically connected by inserting its terminal 53 into the receptacle 65 and securing it with a screw 66.

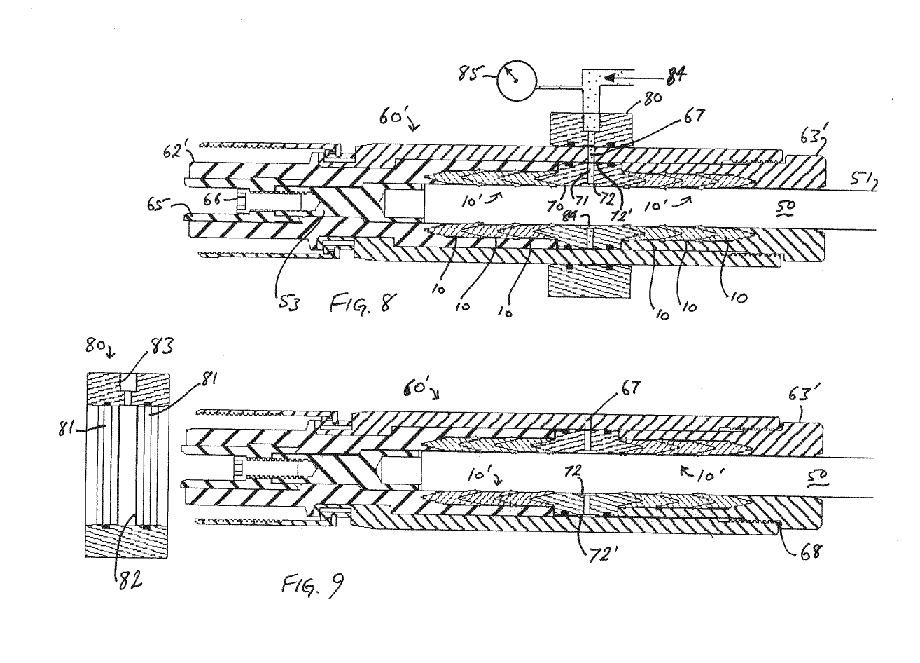

The assembly tool 40 comprises two hemi-cylindrical shells 41, each having an elongate, tapering axial end portion 42, and a part-cylindrical retainer 43 having an axial gap 44 through which the cable 50 can be inserted and removed. The shells are assembled, one on either side of the cable, before the retainer is arranged around the cable as shown (FIG. 7) and then slid axially over the two shells to retain them together (FIG. 4).

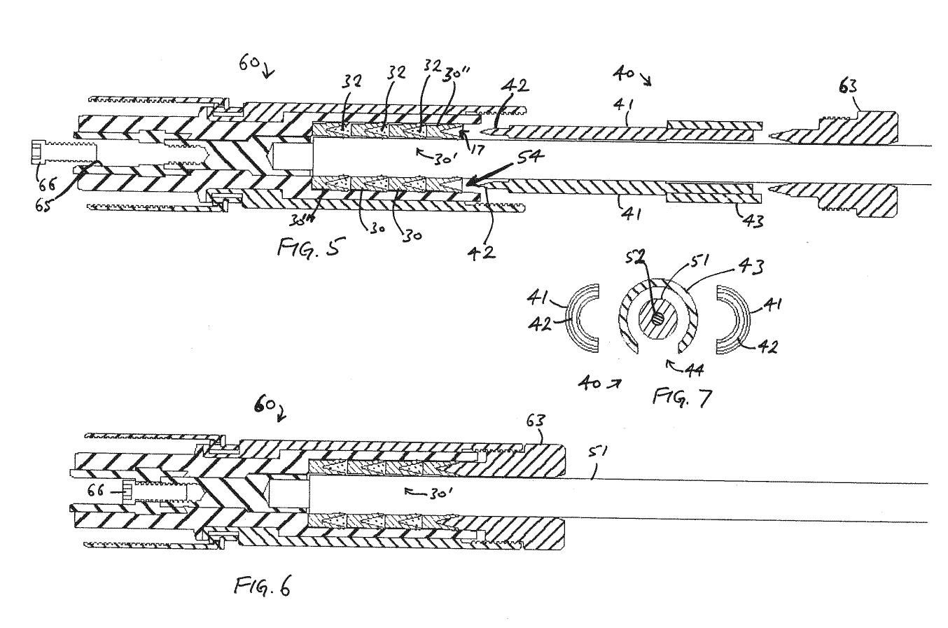

The end portions 42 of the tool 40 cooperate to define an annular insert which fits into the recess 17 in the seal, which in the assembly illustrated is arranged facing out of the annular gap 54 defined between the casing and the sleeve. This insert 42, 42 is slimmer than the insert body 64 of the bush 63, and does not energise the seal into which it fits. Instead, the insert 42, 42 is shaped and dimensioned so as to fit loosely into the recess 17 of each seal, so that there is an annular gap between each of the internal walls 18, 19 of the seal and the insert 42, 42. This allows the recessed portion 15 of each seal 30 to be received in a substantially relaxed condition between the insert 42, 42 of the tool and the inner and outer walls of the annular gap 54 defined respectively by the outer surface of the casing 51 and the inner surface of the insulating sleeve 62. The tool is thus used to push the seals 30 one by one into the gap 54 in a substantially relaxed condition. When the flat end wall 31 of the first seal 30′″ abuts against the shoulder 62′ of the insulating sleeve 62, the tool is withdrawn. An insert body 32 comprising a quantity of non-conductive fluid (e.g. oil) or gel, is then injected into the gap 54 before the second seal 30 is inserted and compressed axially against the first using the tool, with additional insert bodies 32 of fluid or gel and additional seals 30 being installed one by one and progressively axially compressed together one by one in the same manner so as to build up the seal stack 30′ (FIG. 5).

The assembly tool is then disassembled and removed from around the casing. Finally, the bush 63 is screwed into the threaded opening of the outer metallic sleeve 61 so that its insert body 64 enters into the recess 17 of the final seal 30″, energising that seal and further axially compressing the whole seal stack so as to finally energise each of its component seals (FIG. 6). Energisation of the seal stack thus takes place progressively during installation of the seals and finally during assembly of the retaining bush 63.

Referring to FIGS. 8 and 9, a second termination assembly comprises a termination sleeve 60′ having an inner insulating sleeve 62′ and a bush 63′ similar to those of the last mentioned assembly, but adapted for use with two identical energised stacks 10′ of seals 10 according to the first embodiment. The inner sleeve 62′ and bush 63′ are provided with annular, V-shaped recesses corresponding in shape and dimensions to those of the recess 17 in each seal, so that the respective insert bodies of the first and last seals are received respectively in these two recesses.

Each of the two seal stacks is assembled, one seal at a time, using an assembly tool similar to that described above, so that as each annular seal 10 is installed, the male portion (insert body 16) of one seal enters into the annular recess 17 of the adjacent seal, filling the recess and radially energising the recessed portion in the annular gap between the sleeve 62′ and casing 51 as shown. Friction between the insert portion 16 and the walls of the recess 17 tends to retain the insert portion in the recess as the tool is withdrawn, so that the energised seal does not completely relax. Relaxation is also hindered by friction between the sealing beads 21 and 22 and the respective surfaces of the tubular casing and termination sleeve. When the next seal is inserted into the gap, the previously energised seal is further energised. The sealing surfaces and beads of the inner and outer walls of each seal 10 are compressed, respectively against the tubular casing and the internal wall of the sleeve, so that each seal is individually energised, one by one, to a reliably predictable degree.

A spacer 70 is arranged between the two seal stacks 10′, 10′, which are arranged facing in opposite directions in the annular gap, the tips of the assembly tool being interchangeable so as to accommodate the outwardly facing end of each seal. The spacer has two insert bodies which face in opposite axial directions to engage in the recesses of the adjacent seals of the two seal stacks, and one or more radial bores 71 which communicate with inner and outer circumferential recesses 72, 72′. A bore 67 is provided, which extends through the side wall of the sleeve 60′ and communicates with the outer channel 72′ between the first and second energised seal stacks 10′, 10′. A pressure test sleeve 80 having seals 81 and a corresponding internal circumferential recess 82 communicating with a bore 83 is arranged over the sleeve 60′ so that the recess 82 communicates with the bore 67. A non-conductive fluid 84 is injected under pressure via the bores 83, 67 into the recesses 72, 72′ between the first and second energised seal stacks. By measuring the pressure of the fluid 84 via gauge 85, the fluid pressure resistance of each seal stack 10′ may be determined, following which the test sleeve 80 is removed and, optionally, the bore 67 is plugged.

In the embodiment shown, the inner insulating sleeve 62′ terminates just short of the bore 67, and the outer seal stack 10′ is received in a bore defined by the bush 63′, which is sealed to the sleeve 60′ by means of an “O”-ring 68. In alternative embodiments, both the outer and inner seal stacks 10′, 10′ may be sealingly received in the inner insulating sleeve 62′. Test bores may also be provided adjacent the respective ends of the two seal stacks 10′, 10′ remote from the bore 67. An “O”-ring seal may be provided between the terminal 53 and the sleeve 62′ or receptacle 65, allowing a single seal stack 10′ to be pressure tested via a test bore arranged at its inner end, remote from the bush. (It will be understood that the last mentioned “O”-ring seals are compressed by metal-to-metal contact.)

In the embodiments shown, the recess and insert body of each seal are generally “V”-shaped in longitudinal section, which helps the insert body to enter into the recess, but in alternative embodiments they could for example have cooperating rectilinear, lobular or rounded profiles. The recess could also comprise annular internal recesses or barbs which receive or lock into corresponding barbs or recesses of the insert body, which help to prevent each energised seal from relaxing so that it remains in the energised condition until the next seal is energised in turn. The short, cylindrical solid portion of the seal between the recessed portion and the insert body could be slightly tapered, or alternatively could be omitted. A separate insert body, made from compressible or, advantageously, rigid metallic or non-metallic material, could also be arranged adjacent each recess so that it enters into the recess when it is compressed between adjacent seals.

More than one annular recess and more than one sealing bead may be provided. In alternative embodiments, particularly where the insert body is a body of fluid or gel, instead of or in addition to an annular recess, each seal could alternatively comprise a plurality of recesses spaced circumferentially around the end wall of the seal, each recess forming a pocket that extends axially into the seal, preferably with relatively thin walls between adjacent recesses. When the seals are compressed together, the insert body enters into the pockets and expands them so as to energise the seal. In alternative embodiments, the flat walls 31 of the second seals might be rounded or otherwise protuberant.

The seals are preferably elastically deformable, but alternatively could be plastically deformable.

In summary, a preferred seal assembly comprises a plurality of deformable annular seals (10; 30), each having an annular recess (17) at one end, which are inserted one by one in a relaxed condition in coaxial stacked relation into an annular bore (54) and then compressed axially one by one so that an insert body (16; 32) enters into the recess in each seal, radially energising it. The insert body may comprise an opposite end (16) of the adjacent seal, or a body (32) of fluid or gel. The inner wall of each seal comprises a sealing surface and at least one sealing bead protruding radially inwardly from the sealing surface; the sealing surface limits the depth to which the bead can penetrate the casing of the cable.

Although this invention has been described with reference to electric cable terminations, it will be recognised that it may also be employed for terminating pipes, particularly flexible or non-metallic pipes.

Other adaptations may be made within the scope of the claims.

We claim:

1. A seal assembly (10′, 30′) for sealing a tubular casing (51) in a termination sleeve (60, 60′),
including at least two deformable annular seals (10, 30) arranged in stacked coaxial relation;
each seal having first and second axial ends (13, 14);
and a recessed portion (15) proximate the first end;
the recessed portion having a radially inner wall (11), a radially outer wall (12), and at least one recess (17) extending axially from the first end between the inner and outer walls,
the inner and outer walls being arranged to sealingly engage in use, respectively against the tubular casing and the termination sleeve;
an insert body (16, 32) being arranged adjacent each respective recess, each insert body being adapted to enter into the respective recess and radially energise the recessed portion of the seal into which it enters when the seals are compressed together axially;
wherein the inner wall (11) of each seal comprises a sealing surface (11′) and at least one sealing bead (21) protruding radially inwardly from the sealing surface.

2. A seal assembly according to claim 1, characterised in that the sealing surface has a greater axial length than the axial length or combined axial length of the sealing bead or beads.

3. A seal assembly according to claim 1, characterised in that the at least one sealing surface extends axially on either side of the sealing bead or beads.

4. A seal assembly according to claim 1, characterised in that the sealing surface is cylindrical.

5. A seal assembly according to claim 1, characterised in that the at least one recess is annular and axially inwardly tapering, and each seal includes an annular and axially outwardly tapering insert body (16) proximate the second end thereof, the insert body of one of the said at least two seals being arranged adjacent the recess of the other of the said at least two seals.

6. A seal assembly according to claim 1, characterised in that the insert body (32) is a body of fluid or gel.

7. A seal assembly according to claim 1, characterised in that the insert body (32) is a body of water-swellable polymer.

8. A seal assembly according to claim 1, characterised in that the seals are interchangeable.

9. A deformable annular seal (10, 30) for sealing a tubular casing (51) in a termination sleeve (60, 60′),
including first and second axial ends (13, 14);
a recessed portion (15) proximate the first end,
the recessed portion having a radially inner wall (11), a radially outer wall (12), and at least one annular and axially inwardly tapering recess (17) extending axially from the first end between the inner and outer walls,
the inner and outer walls being arranged to sealingly engage in use, respectively against the tubular casing and the termination sleeve;
and an annular and axially outwardly tapering insert body (16) proximate the second end,
the insert body being adapted to enter into the corresponding recess of a second said seal so as to radially energise the recessed portion of the second seal when the seals are arranged in stacked coaxial relation and compressed together axially;
wherein the inner wall (11) comprises a sealing surface (11′) and at least one sealing bead (21) protruding radially inwardly from the sealing surface.

10. A deformable annular seal according to claim 9, wherein the sealing surface has a greater axial length than the axial length or combined axial length of the sealing bead or beads.

11. A deformable annular seal according to claim 9, characterised in that the at least one sealing surface extends axially on either side of the sealing bead or beads.

12. A deformable annular seal according to claim 9, characterised in that the sealing surface is cylindrical.

13. A method of sealing a tubular casing (51) in a termination sleeve (60, 60′), comprising the steps of
a) providing a plurality of deformable annular seals (10, 30),
each seal having first and second axial ends (13, 14)
and a recessed portion (15) proximate the first end;
the recessed portion having a radially inner wall (11), a radially outer wall (12), and at least one recess (17) extending axially from the first end between the inner and outer walls,
the inner wall (11) of each seal comprising a sealing surface (11′) and at least one sealing bead (21) protruding radially inwardly from the sealing surface;
b) arranging the seals in stacked coaxial relation around the tubular casing;
c) inserting the tubular casing into the sleeve so as to define an annular gap between the tubular casing and the sleeve;
d) inserting a first one of the seals into the gap;
e) inserting an insert body (16, 32) together with a further one of the seals into the gap, the insert body being arranged adjacent the recess of the said one of the seals previously inserted;
f) inserting a tool (40) into the gap and urging the tool against the further one of the seals so as to compress it axially against the said one of the seals previously inserted such that the insert body enters into the recess of the said one of the seals previously inserted and radially energises it so that its inner and outer walls sealingly engage respectively against the tubular casing and the termination sleeve;
g) removing the tool from the gap; and
h) repeating steps e), f) and g) one or more times to define a first energised seal stack (10′, 30′).

14. A method according to claim 13, characterised in that the insert body (32) comprises a body of fluid or gel or water-swellable polymer, and the fluid or gel or water-swellable polymer is introduced into the gap between the respective seals.

15. A method according to claim 13, characterised in that the said insert body (16) comprises a portion of the said further one of the seals proximate the second end thereof.

16. A method according to claim 13, characterised by the steps of arranging a second said energised seal stack (10′) in the gap; providing a bore (67) extending through a side wall of the sleeve (60′) at a position between the first and second energised seal stacks; injecting a fluid (84) under pressure via the bore between the first and second energised seal stacks; and measuring the pressure of the fluid.

17. A method according to claim 13, characterised in that each seal is inserted into the gap in a substantially relaxed condition.

18. A method according to claim 13, characterised in that the tubular casing is the non-metallic tubular casing of an electric cable.
